(19) United States
(12) Patent Application Publication
(10) Pub. No.: US 2025/0216055 A1
(43) Pub. Date: Jul. 3, 2025

(54) LED DEVICE WITH A LARGE LIGHT EMISSION ANGLE

(71) Applicant: FOSHAN NATIONSTAR OPTOELECTRONICS CO., LTD., Foshan (CN)

(72) Inventors: Penghui DONG, Foshan (CN); Jieying HUANG, Foshan (CN); Xiang CHEN, Foshan (CN); Junhua CHEN, Foshan (CN); Fabo LIU, Foshan (CN); Danlei GONG, Foshan (CN); Man ZHAO, Foshan (CN); Fuhai LI, Foshan (CN); Zhiguo XIE, Foshan (CN)

(21) Appl. No.: 18/952,505

(22) Filed: Nov. 19, 2024

(30) Foreign Application Priority Data
Dec. 29, 2023 (CN) 202311867442.1

(51) Int. Cl. F21V 13/02; F21V 9/30; F21V 11/08; F21Y 115/10

(52) U.S. Cl. CPC F21V 13/02; F21V 9/30; F21V 11/08; F21Y 2115/10

(57) ABSTRACT

A light-emitting diode (LED) device and module with a large light emission angle include a substrate, an LED chip, a fluorescent adhesive layer, and a shielding layer, where the LED chip is electrically connected to the substrate; the fluorescent adhesive layer wraps and covers a light-emitting surface of the LED chip; the shielding layer tightly covers a top surface of the fluorescent adhesive layer enabling part of the light emitted by the LED chip to be reflected to the side surfaces of the fluorescent adhesive layer and emitted out from the LED device with a large light emission angle; and an interface between the fluorescent adhesive layer and the shielding layer is a curved surface.

### CROSS-REFERENCE TO RELATED APPLICATION(S)

This application claims priority to Chinese Patent Application No. 202311867442.1 filed Dec. 29, 2023, the disclosure of which is incorporated herein by reference in its entirety.

### TECHNICAL FIELD

The present disclosure relates to the field of semiconductor technologies and, in particular, to a light-emitting diode (LED) device with a large light emission angle.

### BACKGROUND

LED modules have the characteristics of high brightness, low energy consumption, and long service life, can satisfy the requirements of various scenarios, and are widely used in display screens, billboards, indoor and outdoor decoration, automotive lighting, and other fields. As the LED modules are used in more and more scenarios in various fields, the traditional LED modules with a light emission angle of 120° can no longer satisfy the usage requirements. Currently, the LED modules are required to emit light more evenly, at a larger light emission angle, and with greater stability. However, LED chips have the characteristic that the luminous intensity decreases as the light emission angle increases. The larger the light emission angle, the weaker the luminous intensity. Therefore, the structure of the LED device needs to be adjusted to achieve a larger light emission angle and a higher side luminous intensity.

FIG. 1 is an LED device with an increased light emission angle in the related art. The LED device includes a substrate 1, a light emission chip 2, a fluorescent adhesive layer 3, a shielding layer 4, and a lens 5. The light emission chip 2 is disposed at the center position of the substrate 1. The fluorescent adhesive layer 3 wraps the five exposed sides of the light emission chip 2 into a cuboid or a cube. The shielding layer 4 covers the top surface of the fluorescent adhesive layer 3 and can reflect part of the light emitted from the top of the light emission chip 2 to the side surfaces. The lens 5 is arc-shaped to further expand the light emission angle of the light emission chip 2.

However, the light formed through the shielding layer 4 of the LED device in the related art is mostly concentrated on the top of the LED device and emitted, and the lens 5 is needed to form a larger light emission angle. In addition, the luminous intensity of the light emitted vertically from the center of the chip is greater than the luminous intensity of the light emitted toward the surrounding region, resulting in uneven light emission. In addition, the fluorescent adhesive layer and the shielding layer of the LED device in the related art are prone to peeling off.

### SUMMARY

The present disclosure provides an LED device with a large light emission angle, which include a substrate, an LED chip, a fluorescent adhesive layer, and a shielding layer, where the LED chip is electrically connected to the substrate; the fluorescent adhesive layer wraps and covers a light-emitting surface of the LED chip; the shielding layer tightly covers a top surface of the fluorescent adhesive layer enabling part of the light emitted by the LED chip to be reflected to the side surfaces of the fluorescent adhesive layer and emitted out from the LED device with a large light emission angle; and an interface between the fluorescent adhesive layer and the shielding layer is a curved surface. In the LED device with a large light emission angle, the fluorescent adhesive layer and the shielding layer are configured to be curved structures to increase the bonding strength of the interface so that more light reflected by the shielding layer is emitted from the side surfaces of the LED device, and the advantages of a large light emission angle and even light emission are ensured.

In some embodiments, the interface between the fluorescent adhesive layer and the shielding layer is a curved surface that is concave toward the center of the fluorescent adhesive layer.

In some embodiments, the interface between the fluorescent adhesive layer and the shielding layer is an arc-shaped curved surface protruding toward the center of the shielding layer.

In some embodiments, the interface between the fluorescent adhesive layer and the shielding layer is an M-shaped curved surface with a concave valley structure.

In some embodiments, the maximum thickness between a top surface and a bottom surface of the shielding layer is less than or equal to 1.00 mm. In this manner, the following is avoided: the shielding layer is too thick and affects the light emission effect of the LED chip.

In some embodiments, the transparency of the shielding layer is set to a value between 50% and 100%. Different transparencies can satisfy the requirements of different side luminous intensities.

In some embodiments, the minimum thickness of the fluorescent adhesive layer corresponding to the center point of the fluorescent adhesive layer is greater than or equal to 0.35 mm. In this manner, the following is avoided: the fluorescent adhesive layer is too thick and affects the light emission effect of the LED chip and the regulation effect of the shielding layer.

In some embodiments, a transparent bracket is further included, where the transparent bracket and the substrate form a cup-shaped structure with an upper opening. In this manner, the fluorescent adhesive layer and the shielding layer are supported.

In some embodiments, the shielding layer contains one or more materials among graphite, graphene, TiO₂, ZnO, ZnS, lithopone, and silver powder, and the mass ratio of the one or more materials in the shielding layer is greater than or equal to 0.1% and is less than or equal to 5%.

The technical solutions of the present disclosure are applied. The fluorescent adhesive layer wraps and covers the light-emitting surface of the LED chip, the shielding layer tightly covers the top surface of the fluorescent adhesive layer, and the interface between the fluorescent adhesive layer and the shielding layer is a curved surface so that part of the light emitted from the front of the chip is reflected, and at the same time, part of the light emitted by the LED chip is reflected to the side surfaces of the fluorescent adhesive layer. In this manner, while the LED device can emit light from five surfaces, the setting of the top reflective shielding layer can redistribute the light emitted by the chip so that the light emission angle of the LED device at the same luminous intensity can be effectively increased, the light emission characteristics of the LED device can be optimized, the practicality of the LED device can be improved, and the color saturation and light-dark contrast of a display screen of a display device manufactured using the LED device provided by the present application can be effectively improved, which is conducive to improving the viewing experience of the user.

For better understanding and implementation, the present disclosure is described in detail below in conjunction with drawings.

### BRIEF DESCRIPTION OF DRAWINGS

FIG. 1 is a schematic diagram of an LED device with an increased light emission angle in the related art.

FIG. 2 is a schematic diagram of an LED device with a large light emission angle according to embodiment one of the present disclosure.

FIG. 3 is a graph illustrating light distribution curves of embodiment one when the transparency is set to 50%.

FIG. 4 is a graph illustrating light distribution curves of embodiment one when the transparency is set to 100%.

FIG. 5 is a schematic diagram of an LED device with a large light emission angle according to embodiment two.

FIG. 6 is a schematic diagram of an LED device with a large light emission angle according to embodiment three.

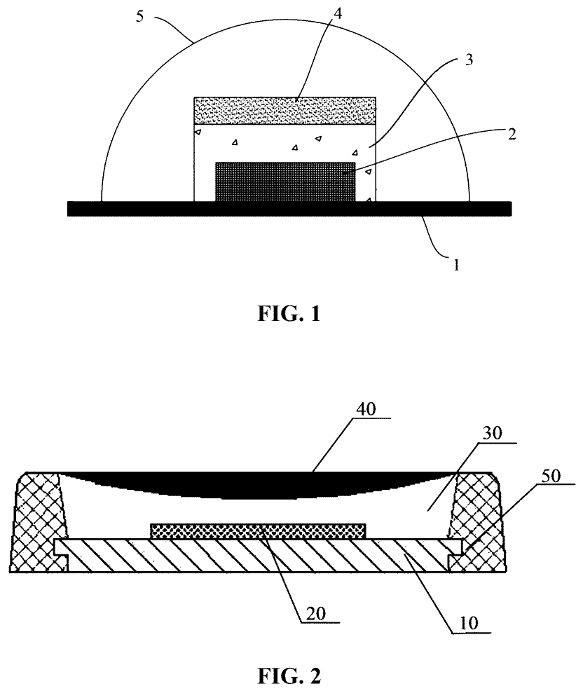

### DETAILED DESCRIPTION

In view of the defect of uneven light emission of the LED device with a large light emission angle in the related art, the inventors make the analysis below. Since the fluorescent adhesive layer is generally pressed into a cuboid or a cube in a molding process, the interface between the fluorescent adhesive layer and the shielding layer is a flat plane. When the light is emitted to the interface plane, on the one hand, the refraction effect of the flat interface structure on the light is limited, the formed refraction angle is relatively small, and after refraction, part of the light emitted vertically is still emitted from the top of the LED device, resulting in uneven light emission of the LED device; on the other hand, the contact surface between the fluorescent adhesive layer and the shielding layer is a plane, and the bonding strength between the two layers is relatively weak.

Based on this, the present disclosure sets the interface between the fluorescent adhesive layer and the shielding layer as a curved surface, which is described in detail below in conjunction with embodiments.

### Embodiment One

Referring to FIG. 2, FIG. 2 is a schematic diagram of an LED device with a large light emission angle according to embodiment one of the present disclosure. The LED device with a large light emission angle of the present disclosure includes a substrate 10, an LED chip 20, a fluorescent adhesive layer 30, and a shielding layer 40. The bottom surface of the LED chip 20 is fixed at the center position of the substrate 10, and the LED chip 20 is electrically connected to the solder pad on the substrate 10. The fluorescent adhesive layer 30 wraps and covers the light-emitting surface of the LED chip 20. The shielding layer 40 tightly covers the top surface of the fluorescent adhesive layer 30 and has light-transmitting and light-reflecting effects.

The LED chip 20 emits light in all directions and has five light-emitting surfaces, including a top light-emitting surface that emits light toward the top and four side light-emitting surfaces that emit light toward the side surfaces. In this embodiment, the luminous intensity of the light from the top light-emitting surface is relatively strong, and the luminous intensity of the light from the side light-emitting surfaces is relatively weak.

The interface between the fluorescent adhesive layer 30 and the shielding layer 40 is a curved surface, and the minimum thickness of the fluorescent adhesive layer 30 corresponding to the center point of the fluorescent adhesive layer 30 is greater than or equal to 0.35 mm. Specifically, in this embodiment, the thickness of the fluorescent adhesive layer 30 becomes thinner from the center to the periphery, and the interface between the fluorescent adhesive layer 30 and the shielding layer 40 is a curved surface that is concave toward the center of the fluorescent adhesive layer 30. The greater the curvature of the interface, the stronger the luminous intensity of the light from the side surfaces of the LED device. The components of the fluorescent adhesive layer 30 include silica gel and fluorescent powder. The fluorescent powder material includes one or more excitable luminescent materials, such as oxynitride, aluminate, silicate, nitride, or sulfide. In some embodiments, the lowest point of the concave of the fluorescent adhesive layer 30 is directly opposite to the light emission center point of the top light-emitting surface of the LED chip 20.

The top surface of the shielding layer 40 is a plane, and the shielding layer 40 has a larger thickness in the center and a smaller thickness on the periphery. The maximum thickness between the top surface and the bottom surface of the shielding layer 40 is less than or equal to 1.00 mm, and the transparency is set to a value between 0 and 100%. The shielding layer 40 is formed by doping a transparent material with materials having different transmittances or refractive indices, and the transparency of the shielding layer 40 is set by setting the component ratio of the shielding layer 40. Specifically, the transparent material is silica gel, silicone resins, or the like. When the transparency is set to 100%, the shielding layer 40 does not include a reflective material or a light-shielding material. When the transparency of the shielding layer is less than 100%, the components of the shielding layer 40 include the reflective material, the light-shielding material, or a mixture of the reflective material and the light-shielding material. The reflective material includes graphite, graphene, or the like. The light-shielding material includes TiO₂, ZnO, ZnS, lithopone, silver powder, or the like. The concentration of the light-shielding material and the concentration of the reflective material may each be set to a value between 0 and 100%, such as 0%, 0.5%, 1%, 10%, 50%, and 100%. Preferably, the transparency is set to a value from 50% to 100%.

Specifically, it is to be noted that in the present application, the content of one or more materials among graphite, graphene, TiO₂, ZnO, ZnS, lithopone, and silver powder in the shielding layer is greater than or equal to 0.1% and is less than or equal to 5%, and the content refers to the ratio of the mass of the preceding material to the mass of the transparent material.

The shielding layer 40 can make part of the light from the top light-emitting surface of the LED chip 20 be emitted along the original optical path direction and part of the light from the top light-emitting surface of the LED chip 20 be reflected to the side surfaces and emitted. The transparency of the shielding layer 40 can be adjusted by adjusting the ratio of silica gel to the light-shielding material and the reflective material. Different thicknesses and transparencies of the shielding layer 40 through which the light emitted by the LED chip 20 passes correspond to different luminous intensities of the light from the side surfaces of the LED device. The thicker the shielding layer 40 is and the lower the transparency is, the stronger the luminous intensity of the light from the side surfaces is. In addition, when the transparency is greater, the luminous intensity at the center of the LED device is greater; when the transparency is smaller, a dark shadow appears in the middle of the LED device. Therefore, the transparency of the shielding layer 40 needs to be designed according to the applicable module. For example, among backlight modules, when the shielding layer 40 is used for a module with larger OD (the optical mixing distance) and Pitch (the distance between adjacent LED devices on a backlight board), it is better to set the transparency of the shielding layer 40 within the range of 50% to 80%; when the shielding layer 40 is used for a module with smaller OD and Pitch, the transparency of the shielding layer 40 is set to be less than or equal to 50%.

In the related art, to make the shape of the fluorescent adhesive layer conform to the theoretical cuboid or cube, the fluorescent adhesive layer is generally solidified first, the shielding layer is applied, and then the shielding layer is solidified. Since the fluorescent adhesive layer and the shielding layer are solidified separately, the bonding between the two layers is not tight enough, and the two layers are prone to peeling off, causing device failure. Therefore, in the present disclosure, the shielding layer 40 and the fluorescent adhesive layer 30 are made of the same transparent material so that the bonding strength of the interface can be increased. Correspondingly, in this embodiment, the transparent material of the shielding layer 40 is silica gel.

Further, in the actual adhesive dispensing process, the light emitted by the LED chip 20 may easily deviate from the focus of the fluorescent adhesive layer 30 or the shielding layer 40, resulting in light scattering, uneven light emission, and poor stability of the light emission effect. Therefore, a transparent bracket 50 is provided in this embodiment. The transparent bracket 50 is an annular enclosure structure disposed on the substrate 10, and the transparent bracket 50 and the substrate 10 form a cup-shaped structure with an upper opening. In order that the LED chip 20 can emit light effectively and sufficient adjustment space is left for the fluorescent adhesive layer 30 and the shielding layer 40, the material of the transparent bracket 50 is polycyclohexylenedimethylene terephthalate (PCT) transparent material, preferably one of epoxy molding compound (EMC) material or sheet moulding compound (SMC) transparent material, and the specifications may be 3 mm*3 mm, 2 mm*2 mm, 1.5 mm*1.5 mm, 1.0 mm*1.0 mm, 0.6 mm*0.6 mm, and other dimensions.

When the LED chip 20 is disposed on the substrate 10, the internal space of the cup-shaped structure is filled with the fluorescent adhesive layer 30 and the shielding layer 40 in turn. Since the fluorescent adhesive layer 30 is supported by the transparent bracket 50, during mass production, the lowest concave point of the fluorescent adhesive can be stabilized at the annular center position of the substrate 10, and the light emitted by the LED chip 20 can pass through the focus of the fluorescent adhesive layer 30 or the shielding layer 40, thereby solving the problems of light scattering, uneven light emission, and poor stability of the light emission effect.

In addition, the fluorescent adhesive layer 30 and the shielding layer 40 in this embodiment may be solidified only once and integrally formed. Specifically, since the transparent bracket 50 is provided, supported by the transparent bracket 50, the fluorescent adhesive layer 30 will not diffuse and extend outward to make the overall thickness thinner. In this manner, the following is not required: the fluorescent adhesive layer 30 is solidified to make the top surface a concave curved surface, and then the shielding layer 40 covering the top surface of the fluorescent adhesive layer 30 is solidified. When a certain amount of shielding layer 40 covers the top surface of the fluorescent adhesive layer 30, under the action of gravity, the interface between the fluorescent adhesive layer 30 and the shielding layer 40 is concave toward the fluorescent adhesive layer 30 to form a curved surface. Therefore, the shielding layer 40 with a suitable thickness in the center may be set by adjusting the amount of the shielding layer 40 so that the interface between the fluorescent adhesive layer 30 and the shielding layer 40 is a curved surface. In this embodiment, the transparent bracket 50 has a specification of 1.5 mm*1.5 mm. When the maximum thickness of the shielding layer 40 is adjusted to 0.25 mm, the interface curvature is 19°. In some embodiments, when the maximum thickness of the shielding layer 40 is adjusted to 0.40 mm, the interface curvature is 30°.

In some embodiments, the top light-emitting surface of the LED chip 20 is further covered with a distributed Bragg reflector (DBR) layer. When the light from the LED chip is emitted toward the DBR layer and refracted by the DBR layer, part of the light is emitted from the side surfaces of the LED chip so that the luminous intensity of the light from the side light-emitting surfaces of the LED chip is stronger. In some embodiments, the bottom surface of the LED chip 20 is also covered with a DBR layer. Since the LED chip covered with the DBR layer has the characteristic of a higher side luminous intensity, correspondingly, the shielding layer 40 that needs to be provided is thinner and the curvature of the interface between the shielding layer 40 and the fluorescent adhesive layer 30 is smaller.

The working principle of the LED device with a large light emission angle described in embodiment one of the present disclosure is introduced below. The main components of the fluorescent adhesive layer 30 and the shielding layer 40 are both silica gel and the refractive index of silica gel ranges from 1.36 to 1.58. Therefore, the light emitted by the LED device of this embodiment produces a certain amount of scattered light under the action of silica gel. Since the interface between the shielding layer 40 and the fluorescent adhesive layer 30 is in the shape of a concave curved surface, when the light emitted by the LED chip 20 passes through the fluorescent adhesive layer 30, the fluorescent material in the fluorescent adhesive layer 30 is excited to emit light of different colors, and the light is refracted by silica gel and emitted toward the shielding layer 40. Since the interface between the shielding layer 40 and the fluorescent adhesive layer 30 is a concave curved surface, part of the light is reflected by the shielding layer 40, passes through the fluorescent adhesive layer 30 and the transparent bracket 50 in sequence, and is emitted from the side surfaces of the LED device, part of the light is refracted by the shielding layer 40 and emitted in a direction deviating from the vertical direction, and the luminous intensity of part of the light emitted vertically upward is weakened under the shielding effect of the shielding layer 40, thereby increasing the light emission angle of the LED device with a large light emission angle.

The fluorescent adhesive layer 30 is a concave curved surface and forms a wrapping force on the shielding layer 40 to a certain extent, thereby increasing the bonding strength between the shielding layer 40 and the fluorescent adhesive layer 30 and making it difficult for the two layers to peel off.

### Effect Test

A test section I(C0/180) is cut out through the center point of the chip of the LED device in the present application along the length direction of the LED device, and another test section I (C90/270) is cut out through the center point of the chip of the LED device in the present application along the width direction. The luminous intensities of the chip on the test sections are tested so that a graph illustrating light distribution curves is obtained. In the graph illustrating light distribution curves, the abscissa refers to the light emission angle, and the ordinate refers to the relative luminous intensity. The relative luminous intensity is the ratio of the luminous intensity of the light at the test angle to the maximum luminous intensity on the test section.

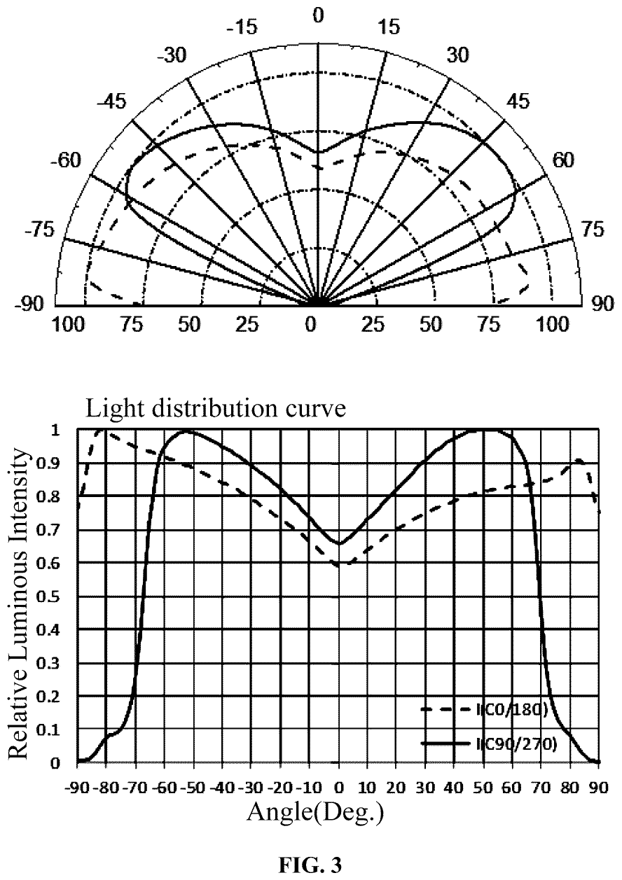

When the transparency of the shielding layer 40 is set to 50%, the graph illustrating light distribution curves of the embodiment is shown in FIG. 3. When the luminous intensity of the LED device is 50%, a line that passes through a point whose vertical ordinate value is 50% and is parallel to the horizontal axis intersects with the I(C90/270) light distribution curve at two points, where the abscissa of the left point of intersection is −65 degrees, and the abscissa of the right point of intersection is 65 degrees. That is to say, in the cutting test plane extending along the width direction of the LED device and passing through the center point of the chip, the distribution range of the light with a luminous intensity of 50% or more of the LED device in the related art is from −65 degrees to 65 degrees, and the span of the distribution range is 130 degrees. When the luminous intensity of the LED device in the present application is 50%, a line that passes through a point whose vertical ordinate value is 50% and is parallel to the horizontal axis intersects with the I(CO/180) light distribution curve at two points, where the abscissa of the left point of intersection is −90 degrees, and the abscissa of the right point of intersection is 90 degrees. That is to say, in the cutting test plane extending along the length direction of the LED device in the present application and passing through the center point of the chip, the distribution range of the light with a luminous intensity of 50% or more of the LED device in the present application is from −90 degrees to 90 degrees, and the span of the distribution range is 180 degrees. The results show that the light emission angle of the LED device can reach 180°. It can be seen that when the transparency of the shielding layer 40 is set to 50%, the light emission angle of the LED device can be effectively increased, and the practicality of the LED device can be improved.

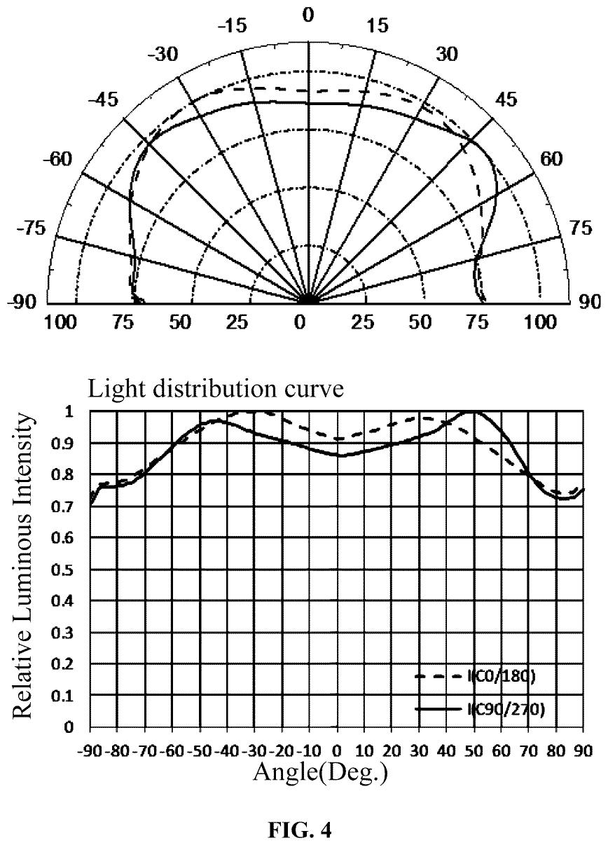

When the transparency of the shielding layer 40 is set to 100%, the graph illustrating light distribution curves of this embodiment is shown in FIG. 4. The results show that the light emission angle of the LED device reaches 180°. When the luminous intensity of the LED device in the present application is 50%, the entire curves are located above a line that passes through a point whose vertical ordinate value is 50% and is parallel to the horizontal axis. That is to say, in the cutting test planes extending along the length and width directions of the LED device in the present application and passing through the center point of the chip, the distribution range of the light with a luminous intensity of 50% or more of the LED device in the present application is from −90 degrees to 90 degrees, and the span of the distribution range is 180 degrees. It can be seen that when the transparency of the shielding layer 40 is set to 100%, the light emission angle of the LED device can be effectively increased, and the practicality of the LED device can be improved.

For the side luminous intensity of the present disclosure, by changing the curved surface shape of the interface between the fluorescent adhesive layer 30 and the shielding layer 40, the luminous intensities at different angles can be adjusted relatively, and the light emission angle of the LED device can be changed, thereby achieving the effect of increasing the luminous intensity, which is specifically described below in conjunction with embodiment two and embodiment three.

### Embodiment Two

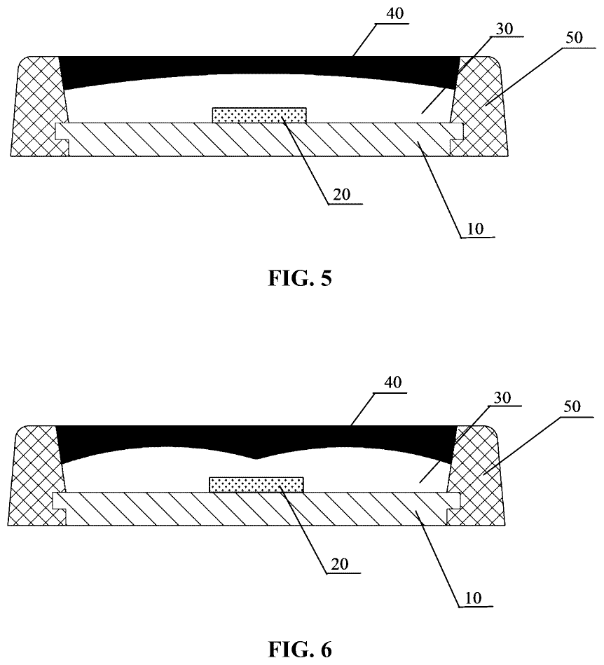

Referring to FIG. 5, FIG. 5 is a schematic diagram of an LED device with a large light emission angle according to embodiment two of the present disclosure. The LED device with a large light emission angle in embodiment two and the LED device with a large light emission angle in embodiment one have basically the same structure. The differences are that the thickness in the center of the fluorescent adhesive layer 30 is greater than that in embodiment one, and the thickness of the fluorescent adhesive layer 30 becomes thinner from the center to the periphery; correspondingly, the thickness in the center of the shielding layer 40 is thinner, and the thickness of the shielding layer 40 becomes thicker from the center to the periphery. The interface between the fluorescent adhesive layer 30 and the shielding layer 40 is an arc-shaped curved surface protruding toward the center of the shielding layer 40.

The effect test shows that the light emission angle of the LED device of this embodiment is between 130° and 160°.

The light emission principle of this embodiment is described below. The light emitted by the device of the present disclosure is scattered under the action of silica gel, the interface between the shielding layer 40 and the fluorescent adhesive layer 30 forms an arc-shaped curved surface protruding in the center, and the fluorescent adhesive layer 30 forms a lens-like structure. After the light emitted by the LED chip 20 passes through the fluorescent adhesive layer 30, the fluorescent material in the fluorescent adhesive layer 30 is excited to emit light of different colors, and under the refraction effect of the lens-like structure, the light is emitted to the side surfaces of the LED device; and the luminous intensity of part of the light emitted vertically upward is weakened under the shielding effect of the shielding layer 40, thereby increasing the light emission angle of the LED device with a large light emission angle.

The fluorescent adhesive layer 30 is an arc-shaped curved surface protruding in the center, and the shielding layer 40 forms a wrapping force on the fluorescent adhesive layer 30 to a certain extent, thereby increasing the bonding strength between the shielding layer 40 and the fluorescent adhesive layer 30 and making it difficult for the two layers to peel off.

### Embodiment Three

Referring to FIG. 6, FIG. 6 is a schematic diagram of an LED device with a large light emission angle according to embodiment three of the present disclosure. The LED device with a large light emission angle in embodiment three and the LED device with a large light emission angle in embodiment two have basically the same structure. The differences are that the thickness around the center point of the fluorescent adhesive layer 30 is thinner, and correspondingly, the thickness around the center point of the shielding layer 40 is thicker. The interface between the fluorescent adhesive layer 30 and the shielding layer 40 is an M-shaped curved surface with a concave valley structure.

The light emission principle of this embodiment is basically the same as that of embodiment two, except that the thickness around the center point of the shielding layer 40 is thicker, thereby further reducing the luminous intensity at the center of the LED device and making the light emission more even.

The effect test shows that the light emission angle of the LED device of this embodiment is between 130° and 160°.

Comparing the present disclosure with the related art, in the present disclosure, the interface between the fluorescent adhesive layer and the shielding layer is configured to be a curved surface, thereby increasing the light emission angle of the device, making the side light emission more even, and enhancing the bonding strength between the fluorescent adhesive layer and the shielding layer to prevent the two layers from peeling off. In addition, the transparent bracket makes the concave center of the fluorescent adhesive layer more stable and enables the fluorescent adhesive layer and the shielding layer to be integrally formed. Further, under the condition that the component ratio of the shielding layer remains unchanged, the curvature of the interface between the fluorescent adhesive layer and the shielding layer may be adjusted by adjusting the amount of the shielding layer, thereby adjusting the side light emission effect to adapt to usage scenarios of different backlight modules.

What is claimed is:

1. A light-emitting diode (LED) device with a large light emission angle, comprising a substrate, an LED chip, a fluorescent adhesive layer, and a shielding layer, wherein the LED chip is electrically connected to the substrate; the fluorescent adhesive layer wraps and covers a light-emitting surface of the LED chip; the shielding layer tightly covers a top surface of the fluorescent adhesive layer enabling part of light emitted by the LED chip to be reflected to side surfaces of the fluorescent adhesive layer and emitted out from the LED device with a large light emission angle; and an interface between the fluorescent adhesive layer and the shielding layer is a curved surface.

2. The LED device with a large light emission angle of claim 1, wherein the interface between the fluorescent adhesive layer and the shielding layer is a curved surface that is concave toward a center of the fluorescent adhesive layer.

3. The LED device with a large light emission angle of claim 1, wherein the interface between the fluorescent adhesive layer and the shielding layer is an arc-shaped curved surface protruding toward a center of the shielding layer.

4. The LED device with a large light emission angle of claim 1, wherein the interface between the fluorescent adhesive layer and the shielding layer is an M-shaped curved surface with a concave valley structure.

5. The LED device with a large light emission angle of claim 1, wherein a maximum thickness between a top surface and a bottom surface of the shielding layer is less than or equal to 1.00 mm.

6. The LED device with a large light emission angle of claim 5, wherein transparency of the shielding layer is set to a value between 50% and 100%.

7. The LED device with a large light emission angle of claim 6, wherein a minimum thickness of the fluorescent adhesive layer corresponding to a center point of the fluorescent adhesive layer is greater than or equal to 0.35 mm.

8. The LED device with a large light emission angle of claim 1, further comprising a transparent bracket, wherein the transparent bracket and the substrate form a cup-shaped structure with an upper opening.

9. The LED device with a large light emission angle of claim 8, wherein the shielding layer contains one or more materials among graphite, graphene, TiO₂, ZnO, ZnS, lithopone, and silver powder, and a mass ratio of the one or more materials in the shielding layer is greater than or equal to 0.1% and is less than or equal to 5%.

10. The LED device with a large light emission angle of claim 2, wherein a maximum thickness between a top surface and a bottom surface of the shielding layer is less than or equal to 1.00 mm.

11. The LED device with a large light emission angle of claim 10, wherein transparency of the shielding layer is set to a value between 50% and 100%.

12. The LED device with a large light emission angle of claim 11, wherein a minimum thickness of the fluorescent adhesive layer corresponding to a center point of the fluorescent adhesive layer is greater than or equal to 0.35 mm.

13. The LED device with a large light emission angle of claim 3, wherein a maximum thickness between a top surface and a bottom surface of the shielding layer is less than or equal to 1.00 mm.

14. The LED device with a large light emission angle of claim 13, wherein transparency of the shielding layer is set to a value between 50% and 100%.

15. The LED device with a large light emission angle of claim 14, wherein a minimum thickness of the fluorescent adhesive layer corresponding to a center point of the fluorescent adhesive layer is greater than or equal to 0.35 mm.

16. The LED device with a large light emission angle of claim 4, wherein a maximum thickness between a top surface and a bottom surface of the shielding layer is less than or equal to 1.00 mm.

17. The LED device with a large light emission angle of claim 16, wherein transparency of the shielding layer is set to a value between 50% and 100%.

18. The LED device with a large light emission angle of claim 17, wherein a minimum thickness of the fluorescent adhesive layer corresponding to a center point of the fluorescent adhesive layer is greater than or equal to 0.35 mm.
